(19) United States
(12) Patent Application Publication
(10) Pub. No.: US 2010/0198659 A1
(43) Pub. Date: Aug. 5, 2010

(54) Methods for matching and managing mentors and mentees and systems thereof

(75) Inventors: Michael Irwin Meltzer, White Plains, NY (US); Jacqueline M. Bassani, Mahopac, NY (US); Peter Rutigliano, Harrington Park, NY (US)

Correspondence Address: NIXON PEABODY LLP - PATENT GROUP, 1100 CLINTON SQUARE, ROCHESTER, NY, 14604, US

(73) Assignee: Sirota Consulting LLC, Purchase, NY (US)

(21) Appl. No.: 12/322,688

(22) Filed: Feb. 4, 2009

(51) Int. Cl. G06Q 10/00

(52) U.S. Cl. 705/11

(57) ABSTRACT

A method, computer readable medium, and system that matches and manages mentors includes determining whether one or more evaluation scores in a plurality of evaluation reports for one or more entities are below a lower threshold and whether one or more of the evaluation scores in the one or more evaluation reports for the one or more entities are above an upper threshold. The one or more of the entities with the one or more evaluation scores determined to be above the upper threshold are matched as a mentor for the one or more of the entities with the corresponding one or more evaluation scores determined to be below the lower threshold based on at least one demographic criteria. One or more review scores are obtained for the one or more of the entities matched as the mentor based on one or more criteria after a first period of time. Recognition is provided to the one or more entities matched as the mentor with one or more of the review scores above a corresponding recognition threshold.

### FIELD

This invention generally relates to methods and systems for mentoring as part of a data based people management protocol and, more particularly, to methods for matching and managing mentors and mentees and systems thereof.

### BACKGROUND

In most businesses, managers periodically receive evaluations on a variety of metrics related to their job performance. These metrics can include areas, such as sales performance, marketing performance, customer relations, the attitudes of workers relating to various management policies and practices, and team management. The results of these evaluations often provide evaluated managers with meaningful feedback on areas of strength as well as areas in need of improvement.

One known method of providing managers additional assistance related to one or more of the evaluated metrics, is to obtain practical guidance by a mentor to whom they are assigned for assistance in those particular areas. These mentor and mentee relationships have the potential to provide valuable and effective training and assistance. Unfortunately, the mentors in these relationships are often are assigned without regard to any particular expertise with respect to the metrics the evaluated managers needs assistance with or any regard to matching the manager on relevant and material attributes, such as demographic information to help facilitate the relationship. As a result, these mentoring programs often fall far short of their goal of improving manager performance in the areas identified needing improvement.

### SUMMARY

A method for matching and managing mentors and mentees in accordance with embodiments of the present invention includes determining with at least a mentoring management system whether one or more evaluation scores in a plurality of evaluation reports for one or more entities are below a lower threshold and whether one or more of the evaluation scores in the one or more evaluation reports for the one or more entities are above an upper threshold. The one or more of the entities with the one or more evaluation scores determined to be above the upper threshold are matched as a mentor for the one or more of the entities with the corresponding one or more evaluation scores determined to be below the lower threshold based on at least one demographic criteria by at least the mentoring management system. One or more review scores are obtained at least with the mentoring management system for the one or more of the entities matched as the mentor based on one or more criteria after a first period of time. Recognition is provided at least by the mentoring management system to the one or more entities matched as the mentor with one or more of the review scores above a corresponding recognition threshold.

A computer readable medium having stored thereon instructions for matching and managing mentors and mentees comprising machine executable code which when executed by at least one processor, causes the processor to perform steps including in accordance with other embodiments of the present invention includes determining whether one or more evaluation scores in a plurality of evaluation reports for one or more entities are below a lower threshold and whether one or more of the evaluation scores in the one or more evaluation reports for the one or more entities are above an upper threshold. The one or more of the entities with the one or more evaluation scores determined to be above the upper threshold are matched as a mentor for the one or more of the entities with the corresponding one or more evaluation scores determined to be below the lower threshold based on at least one demographic criteria. One or more review scores are obtained for the one or more of the entities matched as the mentor based on one or more criteria after a first period of time. Recognition is provided to the one or more entities matched as the mentor with one or more of the review scores above a corresponding recognition threshold.

A system that matches and manages mentors in accordance with other embodiments of the present invention includes a determination system, a matching system, a review system, and a recognition system. Tithe determination system in a mentoring management system is configured to determine whether one or more evaluation scores in a plurality of evaluation reports for one or more entities are below a lower threshold and whether one or more of the evaluation scores in the one or more evaluation reports for the one or more entities are above an upper threshold. The matching system in the mentoring management system is configured to match the one or more of the entities with the one or more evaluation scores determined to be above the upper threshold as a mentor for the one or more of the entities with the corresponding one or more evaluation scores determined to be below the lower threshold based on at least one demographic criteria. The review system in the mentoring management system is configured to obtain one or more review scores for the one or more of the entities matched as the mentor based on one or more criteria after a first period of time. The recognition system is configured to provide recognition to the one or more entities matched as the mentor with one or more of the review scores above a corresponding recognition threshold.

The present invention provides a number of advantages including providing an easier to use and more effective method and system for matching mentors. With the present invention, mentors with demonstrated expertise and skill in an area or areas are identified as a source of mentors. Additionally, with the present invention, the mentees are able to select from this qualified pool of mentors for specialized training and can provide even more detailed feedback to be utilized by future mentees.

### BRIEF DESCRIPTION OF THE DRAWINGS

FIG. 1 is a block diagram of a system that matches and manages mentors and mentees in accordance with embodiments of the present invention; and

FIG. 2 is a flow chart of a method for matching and manages mentors and mentees in accordance with embodiments of the present invention.

### DETAILED DESCRIPTION

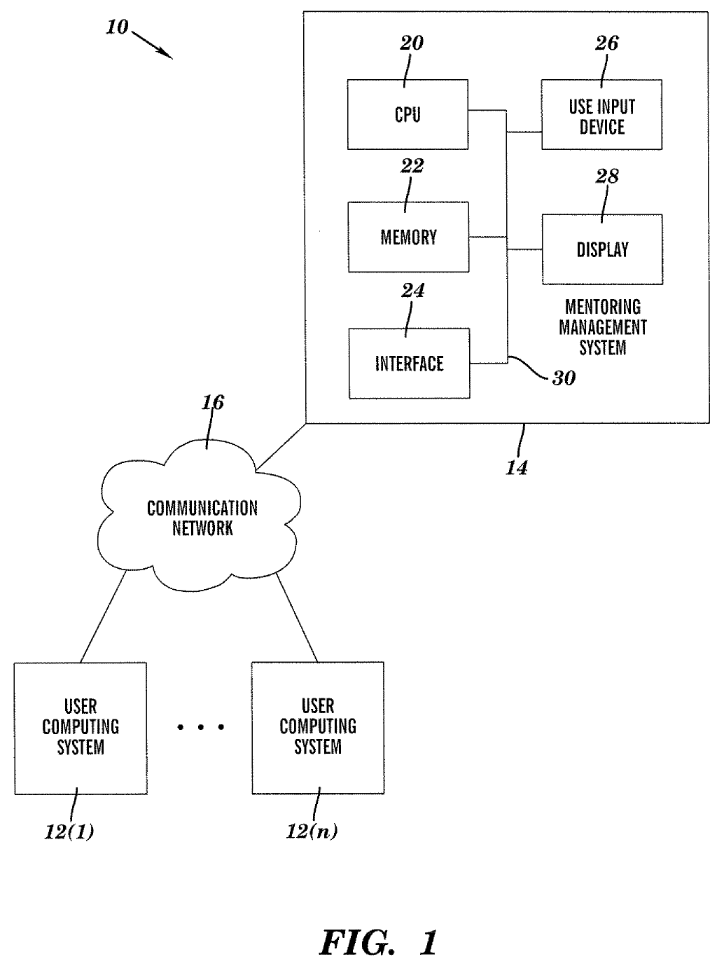

A system 10 that matches and manages mentors and mentees in accordance with embodiments of the present invention is illustrated in FIG. 1. The system 10 includes a plurality of user computing systems 12(1)-12(n) and a mentoring management system 14, although the system can include other types and numbers of systems, device, and elements connected in other manners. The present invention provides an easier to use and more effective method and system for matching mentors.

Referring more specifically to FIG. 1, each of the user computing systems 12(1)-12(n) can perform a variety of different functions, such as submitting responses to questions in evaluation reports, requesting a mentor, agreeing to provide mentoring, receiving and displaying mentoring instructions, providing feedback during mentoring, and providing results to survey questions by way of example only, although other types and numbers of systems could be used for one or more functions and other types and numbers of functions can be performed. Although multiple user computing systems 12(1)-12(n) are shown, the system 10 can have other numbers and types of computing systems and devices.

Each of the user computing systems 12(1)-12(n) includes a central processing unit (CPU) or processor, a memory, user input device, a display, and an interface system, and which are coupled together by a bus or other link, although one or more of the user computing systems 12(1)-12(n) can include other numbers and types of components, parts, devices, systems, and elements in other configurations. The processor in each of the user computing systems 12(1)-12(n) executes a program of stored instructions for one or more aspects of the present invention as described and illustrated herein, although the processor could execute other numbers and types of programmed instructions.

The memory in each of the user computing systems 12(1)-12(n) stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, DVD, or other computer readable medium which is read from and/or written to by a magnetic, optical, or other reading and/or writing system that is coupled to one or more processors, can be used for the memory in each of the user computing systems 12(1)-12(n).

The user input device in each of the user computing systems 12(1)-12(n) is used to input selections, although the user input device could be used to input other types of data and interact with other elements. The user input device can include a computer keyboard and a computer mouse, although other types and numbers of user input devices can be used. The display in each of the user computing systems 12(1)-12(n) is used to show data and information to the user, such as questions in evaluation reports, names of potential mentors, and mentoring instructions by way of example only. The display can include a computer display screen, such as a CRT or LCD screen, although other types and numbers of displays could be used.

The interface system in each of the user computing systems 12(1)-12(n) is used to operatively couple and communicate between the user computing systems 12(1)-12(n) and the mentoring management system 14 via the communications network 16, although other types and numbers of communication networks or systems with other types and numbers of connections and configurations can be used. By way of example only, the communication network 16 can use TCP/IP over Ethernet and industry-standard protocols, including SOAP, XML, LDAP, and SNMP, although other types and numbers of communication networks, such as a direct connection, a local area network, a wide area network, modems and phone lines, e-mail, and wireless communication technology, each having their own communications protocols, can be used.

The mentoring management system 14 has a number of functions, such as receiving and scoring responses to evaluation questions, grouping questions into one or more dimensions or categories, storing data about evaluation reports and surveys, identifying potential mentors and mentees, providing mentor matches, and managing mentor and mentee matches by way of example only, although the mentoring management system 14 can perform other types and numbers of functions and there may be other numbers of management systems. The mentoring management system 14 includes a central processing unit (CPU) or processor 20, a memory 22, an interface system 24, a user input device 26, and a display 28 which are coupled together by a bus 30 or other link, although other numbers and types of systems, devices, and components in other configurations and locations can be used. The processor 20 executes a program of stored instructions for one or more aspects of the present invention as described herein. The memory 22 stores these programmed instructions for one or more aspects of the present invention as described herein as well as other data, although some or all of the programmed instructions and data could be stored and/or executed elsewhere and some or all of this information could be stored at other locations, such as in one or more databases at one or more other locations by way of example only. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to the processor, can be used for the memory in the mentoring management system 14. The interface system 24 is used to identify and operatively couple to a communication network 16 to establish communications between the mentoring management system 14 and the user computing systems 12(1)-12(n), although other types and numbers of communication networks or systems with other types and numbers of connections and configurations to other types and numbers of systems, devices, and components can be used.

The user input device 26 is used by an administrator or other individual to input information, such as lists of designated mentors for different dimensions, individual and aggregate thresholds, list of eligible mentors and mentees and training materials, although the user input device 26 could be used to input other types of data and interact with other elements. The user input device 26 can include a computer keyboard and a computer mouse, although other types and numbers of user input devices can be used. The display 28 is used to show mentoring related information by way of example only, although the display can show other types and amounts of information The display 28 can include a computer display screen, such as a CRT or LCD screen, although other types and numbers of displays could be used.

Although embodiments of the user computing systems 12(1)-12(n) and the mentoring management system 14 are described and illustrated herein, the user computing systems 12(1)-12(n) and the mentoring management system 14 each can be implemented on any suitable computer system or computing device. It is to be understood that the devices and systems of the embodiments described herein are for exemplary purposes, as many variations of the specific hardware and software used to implement the embodiments are possible, as will be appreciated by those skilled in the relevant art(s).

Furthermore, each of the systems of the embodiments may be conveniently implemented using one or more general purpose computer systems, microprocessors, digital signal processors, and micro-controllers, programmed according to the teachings of the embodiments, as described and illustrated herein, and as will be appreciated by those ordinary skill in the art.

In addition, two or more computing systems or devices can be substituted for any one of the systems in any embodiment of the embodiments. Accordingly, principles and advantages of distributed processing, such as redundancy and replication also can be implemented, as desired, to increase the robustness and performance of the devices and systems of the embodiments. The embodiments may also be implemented on computer system or systems that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof.

The embodiments may also be embodied as a computer readable medium having instructions stored thereon for one or more aspects of the present invention as described and illustrated by way of the embodiments herein, as described herein, which when executed by a processor, cause the processor to carry out the steps necessary to implement the methods of the embodiments, as described and illustrated herein.

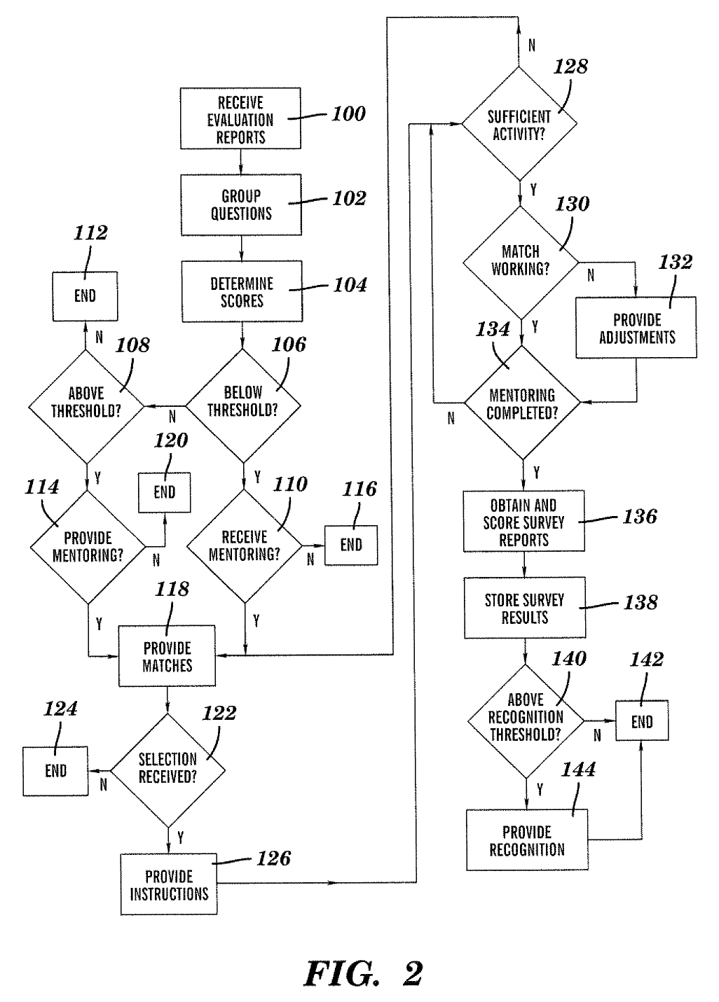

A method for matching and managing mentors and mentees in accordance with an exemplary embodiment will now be described with reference to FIGS. 1-2. Although in this particular example, the processing steps described herein are substantially executed by the mentoring management system 14 as described below, some or all of these steps can be executed by other systems, devices, or components, such as by one or more of the user computing systems 12(1)-12(n).

In step 100, the mentoring management system 14 receives from a user at one or more of the user computing systems 12(1)-12(n) evaluation reports which contain responses to a plurality of evaluation questions about managers in addition to demographic information about the managers and employees, although responses about the performance of managers in one or more areas can be obtained in other manners and from other locations, such as from another computing system or database and other types and amounts of information can be provided. Additionally, although in this particular example the evaluation reports are for managers, evaluation reports for other types of individuals can be obtained. The mentoring management system 14 identifies which evaluation report is associated with which manager and then stores the evaluation reports in memory 22 with an identifier based on the identification, although other manners and locations for storing this data can be used.

In step 102, the mentoring management system 14 may optionally review the plurality of evaluation questions in the evaluation reports and then group one or more of the plurality of questions into one or more dimensions based on one or more characteristics, although other manners for grouping questions can be used. A dimension is an aggregation of questions by content area, although other manners for determining a grouping of questions can be used, such as by using a statistically driven analysis of the questions. By way of example only, a dimension may be a group of questions related to leadership ability, communication skills, management ability, customer relations, or team management, although other types and numbers of questions grouped in other manners can be used.

In step 104, the mentoring management system 14 determines an individual score for each response in each evaluation report based on the particular response. By way of example only, questions have six potential responses: Strongly Agree, Agree, Neutral, Disagree, Strongly Disagree and Not Applicable/Don't Know. Scores are aggregated based on favorable responses (strongly agree and agree). The percent of individuals who responded favorable for each question is then calculated for each manager. Only those individuals who report to this manager will be used in the percent favorable calculation, although evaluations from others could be used if desired. If questions have been grouped into dimensions, then the mentoring management system 14 may also optionally determine an aggregate score for the one or more responses grouped in each of the one or more dimensions by determining an average of the individual scores for those questions as the aggregate score, although a variety of other manners for determining an aggregate score can be used, such as by weighting the value of each of the responses before determining an average score or by totaling the individual scores together.

In step 106, the mentoring management system 14 has lower individual thresholds stored in memory 22 for each of the individual questions and lower aggregate thresholds for each of the dimensions, although the mentoring management system 14 could obtain these thresholds from other locations and in other manners, such as determining the lower individual or aggregate thresholds dynamically based on a bell curve of the responses received from a set of evaluation reports or other relevant statistical methods. The stored thresholds are based on a variety of business related criteria related to the particular organization looking to establish these mentor and mentee relationships, although the thresholds can be based on other criteria. The mentoring management system 14 identifies each of the determined individual scores which are below the corresponding lower individual threshold for the question associated with the determined individual score to identify individuals in need of mentoring in one or more areas, although a variety of other manners for determining a low score can be used. Additionally, if the mentoring management system 14 has determined aggregate scores, then the mentoring management system 14 identifies each of the determined aggregate scores which are below the corresponding lower aggregate threshold for the questions associated with the determined aggregate score to identify individuals in need of mentoring in one or more dimensions, although a variety of other manners for determining a low score can be used. By way of example only, the lower individual threshold or a lower aggregate threshold can be a percentage, such as 55%, or a lower score, such as 60 out of 100, although other types of stored lower aggregate thresholds can be used. If in step 106 the mentoring management system 14 determines that none of the individual scores or aggregate scores in an evaluation report for a manager or other individual are below either a stored lower individual threshold or a stored lower aggregate threshold, then the No branch is taken to step 108. If in step 106 the mentoring management system 14 determines that at least one individual score or aggregate score in an evaluation report for a manager or other evaluated individual is below either a stored lower individual threshold or a stored lower aggregate threshold, then the Yes branch is taken to step 110.

Although in this particular example, the mentoring management system 14 only proceeds to step 108 if none of the individual scores or aggregate scores in an evaluation report for an individual are below either a stored lower individual threshold or a stored lower aggregate threshold, other arrangements can be used. By way of example only, the mentoring management system 14 may determine to proceed to steps 108 and 110 as described above based on an evaluation of the scored results for each question of dimension. This would enable a manager or other evaluated individual who has both low and high scores for questions or dimensions in an evaluation report to both receive mentoring for areas where this individual has low scores and provide mentoring to others for areas where this individual has high scores.

In step 108, the mentoring management system 14 has upper individual thresholds stored in memory 22 for each of the individual questions and upper aggregate thresholds for each of the dimensions, although the mentoring management system 14 could obtain these thresholds from other locations and in other manners, such as determining the upper individual or aggregate thresholds dynamically based on a bell curve of the responses received from a set of evaluation reports. The mentoring management system 14 identifies each of the determined individual scores which is above the corresponding upper individual threshold for the question associated with the determined individual score to identify individuals who can provide mentoring in one or more areas related to the question, although a variety of other manners for determining an upper score can be used. Additionally, if the mentoring management system 14 has determined aggregate scores, then the mentoring management system 14 identifies each of the determined aggregate scores which is above the corresponding upper aggregate threshold for the dimension associated with the determined aggregate score to identify individuals who can provide mentoring in one or more areas related to the dimension, although a variety of other manners for determining an upper score can be used. By way of example only, the upper individual threshold or upper aggregate threshold can be a percentage, such as 85%, or a score, such as 90 our of 100, although other types of stored thresholds can be used. If in step 108 the mentoring management system 14 determines that none of the individual scores or aggregate scores in an evaluation report for a manager or other evaluated individual are above either a stored upper individual threshold or a stored upper aggregate threshold, then the No branch is taken to step 112 where this method ends. If in step 108 the mentoring management system 14 determines that at least one individual score or aggregate score in an evaluation report for a the manager or other evaluated individual is above either a stored upper individual threshold or a stored upper aggregate threshold, then the Yes branch is taken to step 114.

In step 110, the mentoring management system 14 determines if the manager or other evaluated individual with at least one determined individual score or determined aggregate score below the corresponding lower individual threshold for the question or the corresponding lower aggregate threshold for the dimension would like to receive mentoring in the area related to the question or dimension. In this particular example, the mentoring management system 14 sends a query inquiring about interest in receiving this mentoring to the manager or other evaluated individual at one of the user computing systems 12(1)-12(n) and waits for a response accepting or declining the offer to receive mentoring, although other manners for determining interest in receiving mentoring or automatically registering the individual with a low determined individual score or low determined aggregate score to receive mentoring can be used. If the mentoring management system 14 determines the manager or other evaluated individual with at least one determined individual score or determined aggregate score below the corresponding lower individual threshold for the question or the corresponding lower aggregate threshold for the dimension either would not like to receive mentoring in the area related to the question or dimension or does not respond with in a stored response period of time, then the response or absence of a response is stored with other data about the manager or other evaluated individual, such as the manager's evaluation report, and the No branch is taken to step 116 where this method ends. If the mentoring management system 14 determines the manager or other evaluated individual with at least one determined individual score or determined aggregate score below the corresponding lower individual threshold for the question or the corresponding lower aggregate threshold for the dimension either would like to receive mentoring in the area related to the question or dimension, then the response is stored with other data about the manager or other evaluated individual, such as the manager's evaluation report and the Yes branch is taken to step 118.

In step 114, the mentoring management system 14 determines if the manager or other evaluated individual with at least one determined individual score or determined aggregate score above the corresponding upper individual threshold for the question or the corresponding upper aggregate threshold for the dimension would like to provide mentoring in the area related to the question or dimension. In this particular example, the mentoring management system 14 sends a query inquiring about interest in providing this mentoring to the manager or other evaluated individual at one of the user computing systems 12(1)-12(n) and waits for a response accepting or declining the request to provide mentoring, although other manners for determining interest in providing mentoring or automatically registering the manager or other evaluated individual with an upper determined individual score or upper determined aggregate score to provide mentoring can be used. If the mentoring management system 14 determines the manager or other evaluated individual with at least one determined individual score or determined aggregate score above the corresponding upper individual threshold for the question or the corresponding upper aggregate threshold for the dimension would not like to provide mentoring in the area related to the question or dimension, then the response is stored with other data about the manager or other evaluated individual, such as the manager's evaluation report, and the No branch is taken to step 120 where this method ends. If the mentoring management system 14 determines the manager or other evaluated individual with at least one determined individual score or determined aggregate score above the corresponding upper individual threshold for the question or the corresponding upper aggregate threshold for the dimension would like to provide mentoring in the area related to the question or dimension, then the response is stored with other data about the manager or other evaluated individual, such as the manager's evaluation report and the Yes branch is taken to step 118.

In step 118, the mentoring management system 14 provides each manager or other evaluated individual identified as needing and willing to accept mentoring at one of the user computing systems 12(1)-12(n) a list of one or more managers or other individuals identified as qualified and willing to provide mentoring in the corresponding question of dimension in need of improvement and which satisfy at least one demographic criteria, although other manners for providing a list of possible mentors can be used. By way of example only, demographic criteria can comprise age, gender, income, schooling, and occupation and the mentoring management system 14 can look for matches based on stored answer or ranges for acceptable criteria between mentors and mentees, such as being within the same age range, having the same gender, within the same income range, within the same level of schooling, i.e. at least a bachelor's degree for the mentor and mentee. Additionally, other numbers of demographic criteria may need to be met for a match to be made by the mentoring management system 14 in other embodiments. Further, other types and amounts of non-demographic criteria to make a match by the mentoring management system 14 also can be used. By way of example only, other criteria which can be used by the mentoring management system 14 to determine and provide each manager or other evaluated individual a list of one or more possible mentors, include geographic location and language compatibility.

In step 122, the mentoring management system 14 determines if the manager or other evaluated individual who was provided a list of one or more mentors to select has made a selection, although other manners for making a match between the mentor and mentee can be used, such as examining demographic information of the parties and basing the selection on the closest pair. In this particular example, the mentoring management system 14 sends a query with the list of possible mentors to the manager or other evaluated individual in need of mentoring at one of the user computing system 12(1)-12(n) and waits for a response selecting one of the mentors from the list, although other manners for determining a match between mentors and mentees can be used, such as having the mentors select the mentees. If the mentoring management system 14 determines a selection of a mentor has not been received within a stored response period of time, then the absence of a response is stored with other data about the manager or other evaluated individual, such as the manager's evaluation report, and the No branch is taken to step 124 where this method ends. If the mentoring management system 14 determines a selection of a mentor has been received within a stored response period of time, then the response is stored with other data about the manager or other evaluated individual, such as the manager's evaluation report, the selected mentor at one of the user computing systems 12(1)-12(n) is notified of the selection and the Yes branch is taken to step 126.

In step 126, the mentoring management system 14 optionally identifies and retrieves mentoring instructions from memory 22 in an area related to the question or dimension, although the mentoring instructions can be obtained in other manners and from other locations, such as having the mentoring management system 14 search one or more other locations for the mentoring instructions. Once the mentoring management system 14 has identified and retrieved the mentoring instructions, the mentoring management system 14 provides the retrieved mentoring instructions to the manager or other evaluated individual identified as needing mentoring at one of the user computing systems 12(1)-12(n) and the selected mentor at another one of the user computing systems 12(1)-12(n), although the instructions could be provided in other manners, such as just to the manager or other evaluated individual in need of mentoring or just to the selected mentor.

In step 128, the mentoring management system 14 optionally monitors the match between the manager or other evaluated individual in need of mentoring and the selected mentor for activity. In this particular example, the mentoring management system 14 monitors for receipt of one or more reports entered by either the manager or other evaluated individual in need of mentoring at one of the user computing systems 12(1)-12(n) or by the selected mentor at another one of the user computing systems 12(1)-12(n), although other manners of monitoring other types and numbers of activities could be used. If the mentoring management system 14 does not detect any activity between the manager or other evaluated individual in need of mentoring and the selected mentor within a stored period of time, then the No branch is taken back to step 132 where the manager or other evaluated individual in need of mentoring is provided by the mentoring management system 14 another list of possible mentors from a stored list of designated mentors, although other manners for providing the list can be used, such as through manual input at one of the user computing systems 12(1)-12(n). If the mentoring management system 14 does detect activity between the between the manager or other evaluated individual in need of mentoring and the selected mentor, then the Yes branch is taken to step 130.

In step 130, the mentoring management system 14 may optionally monitor to make sure the mentoring relationship is working between the manager or other evaluated individual in need of mentoring and the selected mentor. In this particular example, the mentoring management system 14 periodically polls the manager or other individual in need of mentoring at one of the user computing systems 12(1)-12(n) and the selected mentor at another one of the user computing systems 12(1)-12(n) for a yes or no response if the mentoring relationship is working and then determines if the mentoring relationship is working based on these responses, although other manners for determining if the mentoring relationship is working can be used. If the mentoring management system 14 determines the mentoring relationship is not working, then the No branch is taken to step 132. In step 132, the mentoring management system 14 optionally may provide additional mentoring instructions or may assign another mentor from a database of mentoring facilitators stored in memory 22 to assist with the mentoring relationship, although other manners for providing adjustments to the mentoring relationship can be used. By way of example only, administrative personnel at the mentoring management system 14 can manual set matches through the use of the user input device 26. If the mentoring management system 14 determines the mentoring relationship is working, then the Yes branch is taken to step 134.

In step 134, the mentoring management system 14 determines if the mentoring relationship between the manager or other evaluated individual in need of mentoring and the selected mentor has been completed. In this particular example, the mentoring management system 14 determines the mentoring relationship is completed by receiving a completion indication from the manager or evaluated individual in need of mentoring at one of the user computing systems 12(1)-12(n) or from the selected mentor at another one of the user computing systems 12(1)-12(n) or after the expiration of a stored period of time, although other manners for determining the completion of the mentoring relationship can be used. If the mentoring management system 14 determines the mentoring relationship is completed, then the Yes branch is taken back to step 128 as described earlier. If the mentoring management system 14 determines the mentoring relationship is completed, then the Yes branch is taken back to step 136.

In step 136, the mentoring management system 14 provides and receives from the manager or other evaluated individual at one of the user computing systems 12(1)-12(n) a survey report which contain responses to a plurality of survey questions about the mentoring relationship, although responses about the performance of the selected mentor can be obtained in other manners and from other locations, such as from another computing system or database. Additionally, the mentoring management system 14 determines a score or rating for the responses in the survey report. In this particular example, questions have six potential responses: Strongly Agree, Agree, Neutral, Disagree, Strongly Disagree and Not Applicable/Don't Know. Scores are aggregated based on favorable responses (strongly agree and agree). The percent of individuals who responded favorable for each question about the mentoring relationship is then calculated. With these scores, the mentoring management system 14 determines an overall mentor score for the selected mentor by averaging the determined scores, although other manners for determining a score or rating of the selected mentor's performance can be used.

In step 138, the mentoring management system 14 identifies which survey report is associated with which selected mentor and then stores the survey report along with the determined overall mentor score in memory 22 with an identifier based on the identification, although other manners and locations for storing this data can be used.

In step 140, the mentoring management system 14 has an upper recognition threshold stored in memory 22 for the results of the survey reports, although the mentoring management system 14 could obtain this threshold from other locations and in other manners, such as determining the upper recognition threshold dynamically based on a bell curve of the responses received from a set of survey reports. The mentoring management system 14 determines if the overall mentor score is above the corresponding upper recognition threshold. By way of example only, the upper recognition threshold can be a percentage, such as 85%, or a score, such as 90 our of 100, although other types of stored thresholds can be used. If in step 140 the mentoring management system 14 determines that the overall mentor score for the selected mentor is at or below the stored upper recognition threshold, then the No branch is taken to step 142 where this method ends. If in step 140 the mentoring management system 14 determines that the overall mentor score for the selected mentor is above the stored upper recognition threshold, then the Yes branch is taken to step 144. In step 144, the mentoring management system 14 provides recognition to the selected mentor at one of the user computing systems 12(1)-12(n), such as providing recognition electronically through company newsletters or electronically through remarks provided at employee performance appraisals by way of example only, although other manners for providing recognition can be used. Once the recognition has been provided, the method proceeds to step 142 where this embodiment ends.

Accordingly, as illustrated and described herein the present invention provides an easier to use and more effective method and system for matching mentors.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefor, is not intended to limit the claimed processes to any order except as may be specified in the claims. Accordingly, the invention is limited only by the following claims and equivalents thereto.

What is claimed is:

1. A method for matching and managing mentors and mentees, the method comprising:
determining with at least a mentoring management system whether one or more evaluation scores in a plurality of evaluation reports for one or more entities are below a lower threshold;
determining with at least the mentoring management system whether one or more of the evaluation scores in the one or more evaluation reports for the one or more entities are above an upper threshold;
matching with at least the mentoring management system at least one of the one or more of the entities with the one or more evaluation scores determined to be above the upper threshold as a mentor for at least one of the one or more of the entities with the corresponding one or more evaluation scores determined to be below the lower threshold based on at least one demographic criteria;
obtaining at least with the mentoring management system one or more review scores for the at least one of the one or more of the entities matched as the mentor based on one or more evaluation criteria after a first period of time; and
providing at least by the mentoring management system recognition to the one or more entities matched as the mentor with one or more of the review s cores above a corresponding recognition threshold.

2. The method as set forth in claim 1 further comprising:
obtaining at least with the mentoring management system a response to one or more of a plurality of questions in the plurality of evaluation reports, each of the plurality of evaluation reports is associated with one of the one or more entities; and
determining with at least the mentoring management system the evaluation score for each of the responses to each of the one or more of the plurality questions.

3. The method as set forth in claim 1 further comprising:
obtaining at least by the mentoring management system a response to one or more of a plurality of questions in the plurality of evaluation reports, each of the plurality of evaluation reports is associated with one of the one or more entities;
grouping with at least the mentoring management system one or more of the responses to the plurality of questions into one or more dimensions based on one or more characteristics;
determining with at least the mentoring management system an evaluation score for the one or more responses to each of the plurality of questions grouped in each of the one or more dimensions.

4. The method as set forth in claim 2 wherein the matching further comprises:
obtaining at least with the mentoring management system a selection to receive mentoring with respect to at least one of the plurality of questions from the one or more of the entities with the one or more evaluation scores below the lower threshold;
obtaining with at least the mentoring management system a selection to provide mentoring with respect to at least one of the plurality of questions from the one or more of the entities with the one or more evaluation scores above the upper individual threshold;
providing at least with the mentoring management system one or more matches between one or more of the obtained selections to provide mentoring which correspond based on the one of the plurality of questions with at least one of the one or more obtained selections to receive mentoring; and
matching at least with the mentoring management system based on an obtained selection of one or more of the provided matches.

5. The method as set forth in claim 2 wherein the matching further comprises:
obtaining at least with the mentoring management system a selection to receive mentoring with respect to at least one of the one or more dimensions from the one or more of the entities with the one or more evaluation scores below the lower threshold;
obtaining at least with the mentoring management system a selection to provide mentoring with respect to at least one of the one or more dimensions from the one or more of the entities with the one or more evaluation scores above the upper individual threshold;
providing with at least the mentoring management system one or more matches between one or more of the obtained selections to provide mentoring which correspond based on the one of the one or more dimensions with at least one of the one or more obtained selections to receive mentoring; and
matching with at least the mentoring management system based on an obtained selection of one or more of the provided matches.

6. The method as set forth in claim 4 further comprising providing with at least the mentoring management system one or more instructions on mentoring based at least on the matching and the corresponding one of the plurality of questions.

7. The method as set forth in claim 5 further comprising providing with at least the mentoring management system one or more instructions on mentoring based at least on the matching and the corresponding one of the one or more dimensions.

8. The method as set forth in claim 1 further comprising monitoring with at least the mentoring management system one or more mentoring activities related to the matching, wherein the matching provides another match after unrecorded activity for a first period of time.

9. The method as set forth in claim 1 further comprising:
determining with at least the mentoring management system whether the matching meets one or more standards during mentoring; and
providing with at least the mentoring management system one or more adjustment instructions when the determining indicates the matching is not meeting one or more standards.

10. The method as set forth in claim 1 further comprising storing with at least the mentoring management system the one or more review scores for the one or more of the entities matched as the mentor.

11. A computer readable medium having stored thereon instructions for matching and managing mentors and mentees comprising machine executable code which when executed by at least one processor, causes the processor to perform steps comprising:
determining whether one or more evaluation scores in a plurality of evaluation reports for one or more entities are below a lower threshold;
determining whether one or more of the evaluation scores in the one or more evaluation reports for the one or more entities are above an upper threshold;
matching the one or more of the entities with the one or more evaluation scores determined to be above the upper threshold as a mentor for the one or more of the entities with the corresponding one or more evaluation scores determined to be below the lower threshold based on at least one demographic criteria;
obtaining one or more review scores for the one or more of the entities matched as the mentor based on one or more criteria after a first period of time; and
providing recognition to the one or more entities matched as the mentor with one or more of the review scores above a corresponding recognition threshold.

12. The medium as set forth in claim 11 further comprising:
obtaining a response to one or more of a plurality of questions in the plurality of evaluation reports, each of the plurality of evaluation reports is associated with one of the one or more entities; and
determining the evaluation score for each of the responses to each of the one or more of the plurality questions.

13. The medium as set forth in claim 11 further comprising:
obtaining a response to one or more of a plurality of questions in the plurality of evaluation reports, each of the plurality of evaluation reports is associated with one of the one or more entities;
grouping one or more of the responses to the plurality of questions into one or more dimensions based on one or more characteristics;
determining an evaluation score for the one or more responses to each of the plurality of questions grouped in each of the one or more dimensions.

14. The medium as set forth in claim 12 wherein the matching further comprises:
obtaining a selection to receive mentoring with respect to at least one of the plurality of questions from the one or more of the entities with the one or more evaluation scores below the lower threshold;
obtaining a selection to provide mentoring with respect to at least one of the plurality of questions from the one or more of the entities with the one or more evaluation scores above the upper individual threshold;
providing one or more matches between one or more of the obtained selections to provide mentoring which correspond based on the one of the plurality of questions with at least one of the one or more obtained selections to receive mentoring; and
matching based on an obtained selection of one or more of the provided matches.

15. The medium as set forth in claim 12 wherein the matching further comprises:
obtaining a selection to receive mentoring with respect to at least one of the one or more dimensions from the one or more of the entities with the one or more evaluation scores below the lower threshold;
obtaining a selection to provide mentoring with respect to at least one of the one or more dimensions from the one or more of the entities with the one or more evaluation scores above the upper individual threshold;
providing one or more matches between one or more of the obtained selections to provide mentoring which correspond based on the one of the one or more dimensions with at least one of the one or more obtained selections to receive mentoring; and
matching based on an obtained selection of one or more of the provided matches.

16. The medium as set forth in claim 14 further comprising providing one or more instructions on mentoring based at least on the matching and the corresponding one of the plurality of questions.

17. The medium as set forth in claim 15 further comprising providing one or more instructions on mentoring based at least on the matching and the corresponding one of the one or more dimensions.

18. The medium as set forth in claim 11 further comprising monitoring one or more mentoring activities related to the matching, wherein the matching provides another match after unrecorded activity for a first period of time.

19. The medium as set forth in claim 11 further comprising:
determining whether the matching meets one or more standards during mentoring; and
providing one or more adjustment instructions when the determining indicates the matching is not meeting one or more standards.

20. The medium as set forth in claim 1I further comprising storing the one or more review scores for the one or more of the entities matched as the mentor.

21. A system that matches and manages mentors, the system comprising:
a determination system in a mentoring management system configured to determine whether one or more evaluation scores in a plurality of evaluation reports for one or more entities are below a lower threshold and whether one or more of the evaluation scores in the one or more evaluation reports for the one or more entities are above an upper threshold;
a matching system in the mentoring management system configured to match the one or more of the entities with the one or more evaluation scores determined to be above the upper threshold as a mentor for the one or more of the entities with the corresponding one or more evaluation scores determined to be below the lower threshold based on at least one demographic criteria;
a review system in the mentoring management system configured to obtain one or more review scores for the one or more of the entities matched as the mentor based on one or more criteria after a first period of time; and
a recognition system in the mentoring management system configured to provide recognition to the one or more entities matched as the mentor with one or more of the review scores above a corresponding recognition threshold.

22. The system as set forth in claim 21 further comprising an evaluation system in at least the mentoring management system configured to obtain a response to one or more of a plurality of questions in the plurality of evaluation reports, each of the plurality of evaluation reports is associated with one of the one or more entities, wherein the determination system determines the evaluation score for each of the responses to each of the one or more of the plurality questions.

23. The system as set forth in claim 21 further comprising an evaluation system in at least the mentoring management system configured to obtain a response to one or more of a plurality of questions in the plurality of evaluation reports, each of the plurality of evaluation reports is associated with one of the one or more entities; and
a grouping system in at least the mentoring management system configured to group one or more of the responses to the plurality of questions into one or more dimensions based on one or more characteristics, wherein the determination system determines an evaluation score for the one or more responses to each of the plurality of questions grouped in each of the one or more dimensions.

24. The system as set forth in claim 22 wherein the matching system further comprises:
a selection system in at least the mentoring management system configured to obtain a selection to receive mentoring with respect to at least one of the plurality of questions from the one or more of the entities with the one or more evaluation scores below the lower threshold and obtains a selection to provide mentoring with respect to at least one of the plurality of questions from the one or more of the entities with the one or more evaluation scores above the upper individual threshold; and
a communication system in at least the mentoring management system configured to provide one or more matches between one or more of the obtained selections to provide mentoring which correspond based on the one of the plurality of questions with at least one of the one or more obtained selections to receive mentoring; the matching system matches based on an obtained selection of one or more of the provided matches.

25. The system as set forth in claim 22 wherein the matching system further comprises:
a selection system in at least the mentoring management system configured to obtain a selection to receive mentoring with respect to at least one of the one or more dimensions from the one or more of the entities with the one or more evaluation scores below the lower threshold and obtains a selection to provide mentoring with respect to at least one of the one or more dimensions from the one or more of the entities with the one or more evaluation scores above the upper individual threshold; and
a communication system in at least the mentoring management system configured to provide one or more matches between one or more of the obtained selections to provide mentoring which correspond based on the one of the one or more dimensions with at least one of the one or more obtained selections to receive mentoring, the matching system matches based on an obtained selection of one or more of the provided matches.

26. The system as set forth in claim 24 further comprising a mentoring instruction system in at least the mentoring management system configured to provide one or more instructions on mentoring based at least on the match and the corresponding one of the plurality of questions.

27. The system as set forth in claim 25 further comprising a mentoring instruction system in at least the mentoring management system configured to provide one or more instructions on mentoring based at least on the match and the corresponding one of the one or more dimensions.

28. The system as set forth in claim 21 further comprising a monitoring system in at least the mentoring management system configured to monitor one or more mentoring activities related to the matching, wherein the matching system provides another match after unrecorded activity by the monitoring system for a first period of time.

29. The system as set forth in claim 21 further comprising an oversight system in at least the mentoring management system configured to determine whether the match meets one or more standards during mentoring and provides one or more adjustment instructions when the match is not meeting one or more standards.

30. The system as set forth in claim 21 further comprising a storage system in at least the mentoring management system configured to store the one or more review scores for the one or more of the entities matched as the mentor.
